(19) United States
(12) Patent Application Publication
(10) Pub. No.: US 2012/0073428 A1
(43) Pub. Date: Mar. 29, 2012

(54) PREFABRICATED CONSTRUCTION OBJECT WHICH IS BUILT FROM PREFABRICATED FEROCEMENT RIB ELEMENTS BY SANDWICH TYPE WHICH ARE EFFUSED IN MOULDS

(76) Inventors: Milenko Milinkovic, Boljevci (RS); Mladen Milinkovic, Biljevci (RS)

(21) Appl. No.: 13/265,319

(22) PCT Filed: Mar. 23, 2010
(86) PCT No.: PCT/RS10/00002

§ 371 Date: Oct. 19, 2011

(30) Foreign Application Priority Data
Feb. 19, 2009 (RS) P-2009/0078

(51) Int. Cl. F41H 5/24; B28B 7/22; E04B 7/10

(52) U.S. Cl. 89/36.04; 52/81.6; 249/13; 89/917; 89/920

(57) ABSTRACT

Prefabricated ribbed ferrocement element E sandwich type is effused in the mould K with vibrating motor 14 embedded, and it consist from box looking shell 15 made from ferrocement with fortified ribs 16 thermal isolation layer 17 and protective layer 5; on the side of the elements E hooks 18 have been positioned made from armature and used for removing elements from the mould K and his placement on the construction site. Moustaches 19 made from armature and positioned on the frontal side of the element serve for binding with armature of the reinforced concrete arches 6; they have an optional openings 8 made for windows, ventilation and other installations. A construction structure is constructed using the prefabricated ribbed ferrocement element E.

### TECHNICAL FIELD

In general invention is referring on the area of high rise building; more specifically on construction of housing, business, sports medical and educational structures as well as industrial, manufacturing, storing halls and cooler storages. Structures are resistant on earthquakes, strong winds, floods and consequences caused by climate change. Besides these factors invention is referring on construction of ferrocement sandwich panels in special moulds.

According to the International classification of patents main object of patent is diversified. In other words patent is sorted and marked using symbols E04H 3/00, E04H 9/14, E04H 9/16, E04B 7/10, E04G 11/00 and E04C 1/40.

This invention is resolving some technical problems such as: how to construct big enclosed space—high rise objects in the shape of arched structures using sandwich type ferrocement elements effused in special moulds, structures are multipurpose, functional flexible, easy for maintenance, resistant on seismic influences strong winds and other natural disasters on quick and simple way using non expensive but high quality materials available to everyone by using standard construction devices and resources.

### BACKGROUND ART

Ferrocement technology was first time applied in 1848 year for construction of ferrocement boat (patented 1852) but until eighties in twenty century was not noticeably used in construction industry.

Last thirty years in the world using technology of ferrocement high rise structures have been constructed as integral objects by using skeleton method or by putting together flat prefabricated ferrocement elements (walls, ceilings), and elements curved on one axis (roof elements).

Disadvantages of first construction method are that it requires lot of time for manual placement and bounding of nets as well as permanent problem of quality of workmanship during imprinting of mortar.

Disadvantages of second method are inadequate form of the elements needed for successful solving of static problems and high price of moulds.

In all existing technologies for production of ferrocement construction elements, it is necessary to prefabricate carrying elements (columns girders, arches) usually in many different dimensions which are then transported to the construction site (often nonstandard transportation means) where they are assembled and where the fulfill of the structure is formed (by using panels, building etc).

Adopted solution for construction of structures made by using prefabricated ferrocement elements and their production in special moulds is essentially different from all used technologies for construction of structures whether they are made from concrete, steel or wooden elements.

In adopted solutions elements that are forming fulfill for the structure are prefabricated and carrying construction is formed by effusion of reinforced concrete on the construction site during assembly process.

After research of patent documentation and inspection of scientific literature within this area of expertise, it is determined that similar solution for the technical problem does not exist. Only by using adopted solution it is possible to build construction structures by using only one type of prefabricated elements.

### DISCLOSURE OF INVENTION

Core of this invention is to enable forming of the half cylindrical objects different dimensions on construction site by bounding ferrocement elements made in moulds. On the construction site elements are positioned on the subsidiary demountable steel scaffold by gluing them together using construction glue. This way in the space between elements bearing reinforced concrete arches are connected in the net with reinforced concrete girders located in the frame (ribs) of elements.

Assembly starts in such a way that besides high quality construction glue placed on the foundational ribbons two elements are placed on each side with mutual space appointed for effusion of reinforced concrete arch. Process of assembly is continued with placement (building) next rows of elements on both sides one after another with gluing. This is the way two semicircular rows of glued elements are made. Space between semicircular rows of glued elements is armored, closed using plating, filled with concrete using vibrating motor. This is the way reinforced concrete arch (polygonal arch) is formed and he represents main carrying structure.

In comparison with other systems of prefabrication submitted system consists from only one type of elements compared to existing system which have many different elements (different columns, girders, panels and divisions) mainly bearing elements are prefabricated and they usually have different, high dimensions and weights. Another important difference is that suggested elements represent fulfill for the structure while main bearing elements are formed in the “monolithic” process.

In proposed invention using method of effusion in mould, ribbed ferrocement elements sandwich type are prefabricated as segments of half cylinder which are bounded with purpose of building high rise elements.

Mould has a shape of polyhedron and it is made from steel gridded looking structure covered with metal plate. Sides of the mould are made from steel plate and are designed in a way that it is possible to move them translational away from mould in order to remove element. Body of the mould and his sides are positioned on the mould carrier and the connection is embroidered with rubber bearers. Under the body of the mould electro vibrating—motor is positioned and he is contributing to the structural monoliths of ferrocement elements.

An element which has been effused in a mould is produced as sandwich element and it consist from: box looking shell made from ferrocement with fortified ribs and finishing thermal isolation layer. In order to remove element from the mould and to place him on the construction site armature hooks protruding from the ribbed part of elements are used. “Moustaches” made from armature are used for binding elements with armature in reinforced—concrete arches after they have been placed on the construction site. It is possible to install “blind” frames for planned openings (windows).

After they have been removed from the mould elements are laid out on the special metal palette. Between the elements inserts are placed. Five elements stacked in such a manner represent a packet. Packet is then secured and tied down with bracket for easier transportation. In the standard truck for transportation it is possible to load five packages. Such a transport is in the domain of overall transportation parameters.

### BRIEF DESCRIPTION OF DRAWINGS

Invention has been described in detail on the examples of execution presented on the outline in which:

FIG. 1—showing characteristic cross section throughout the structure with subsidiary demountable construction.

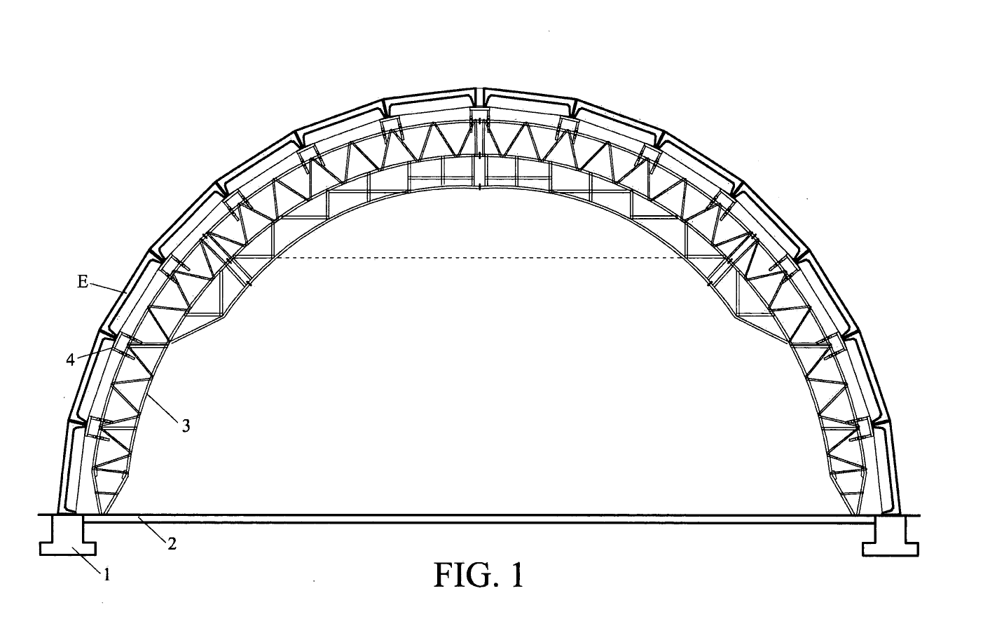

FIG. 2—showing ferrocement elements on the subsidiary structure during construction of the object showed in the perspective.

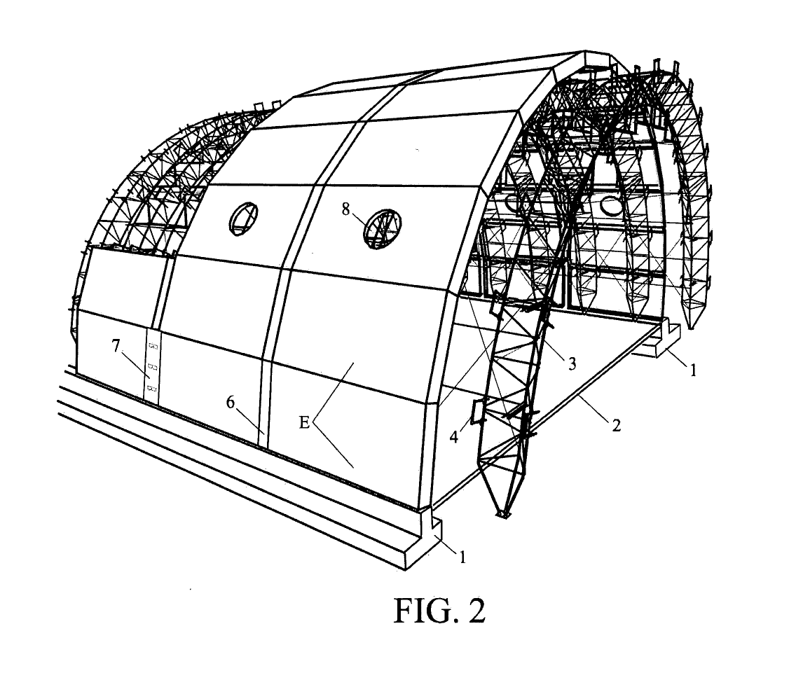

FIG. 3—showing inside look of the finished object shown in the perspective

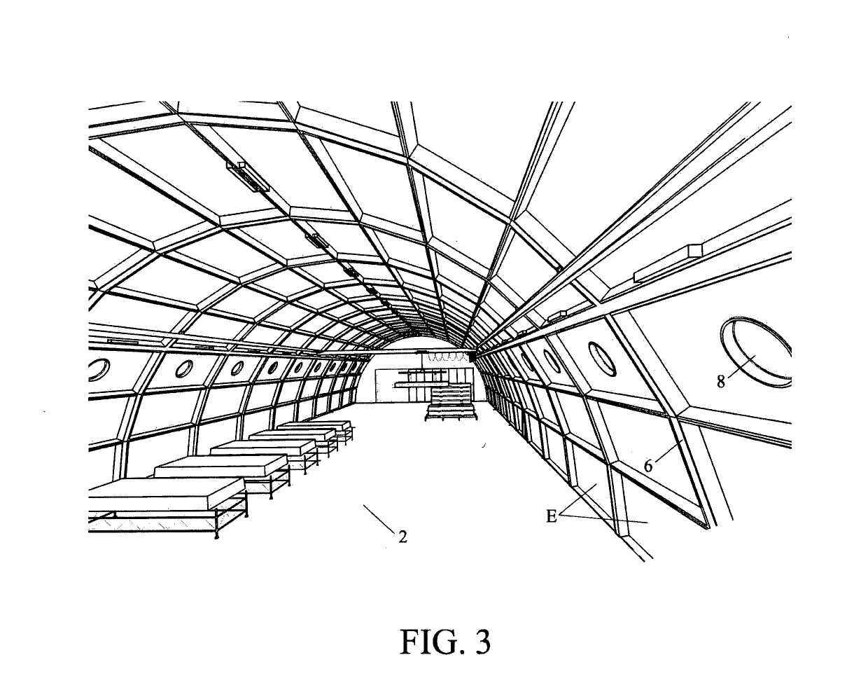

FIG. 4—showing mould from the bird perspective

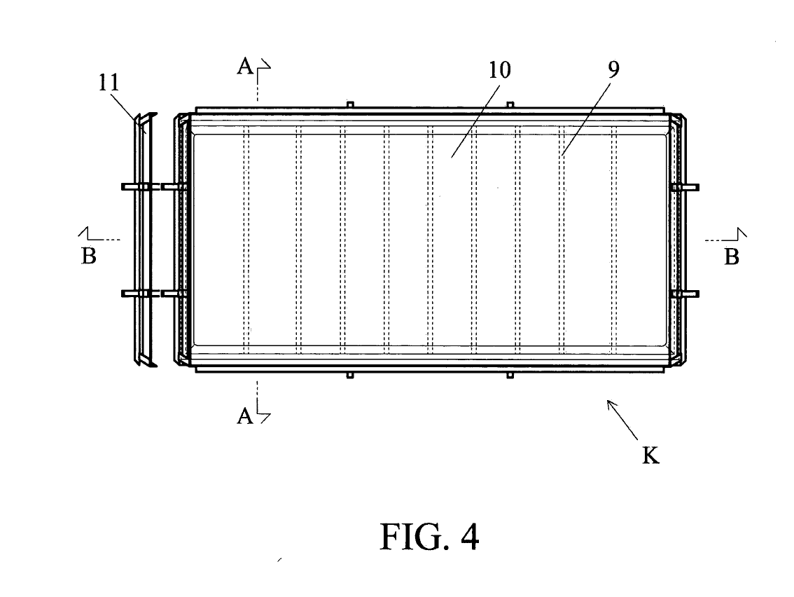

FIG. 5—showing cross section of the mould made from intersection A-A from picture 1,

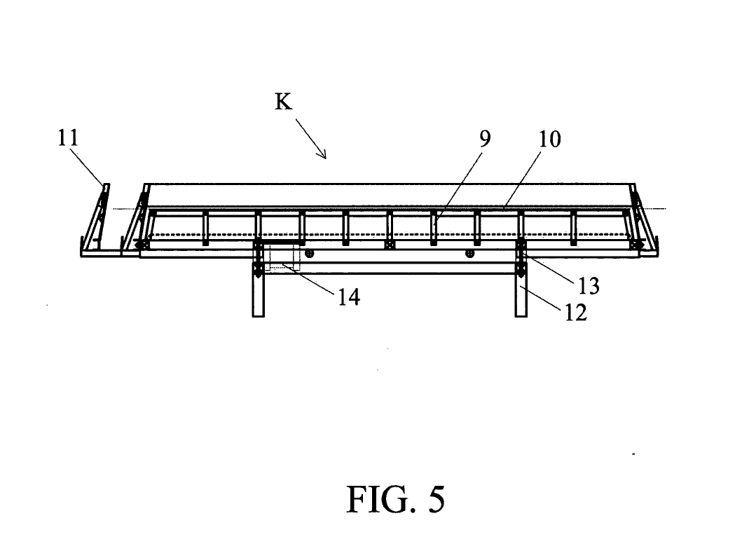

FIG. 6—showing cross section of the mould made from intersection throughout B-B from picture 1

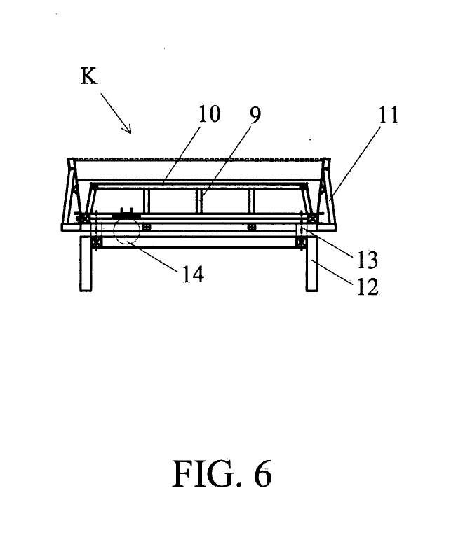

FIG. 7—showing outlook of the mould in the perspective

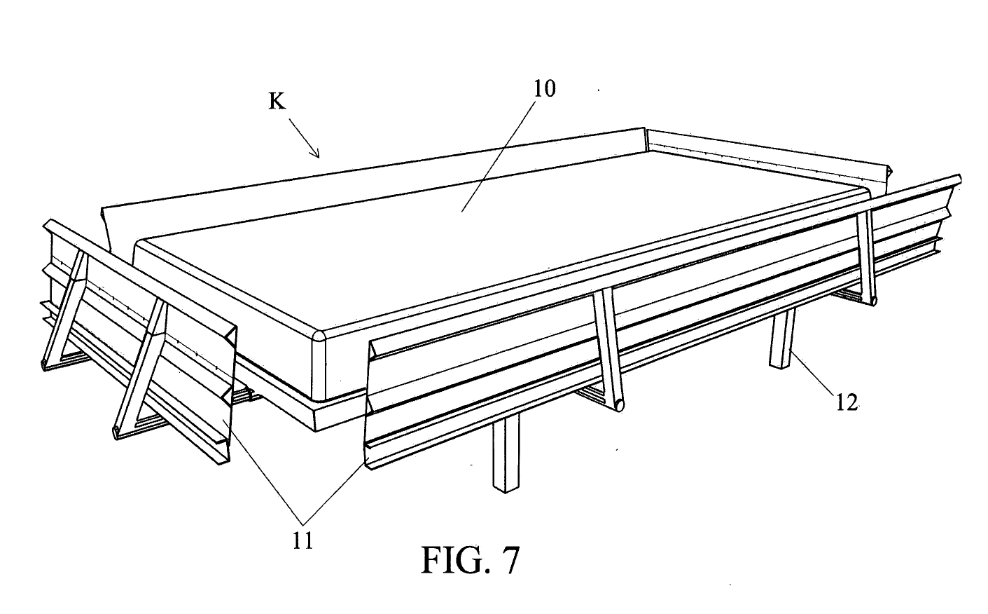

FIG. 8—showing foundation of ferrocement element

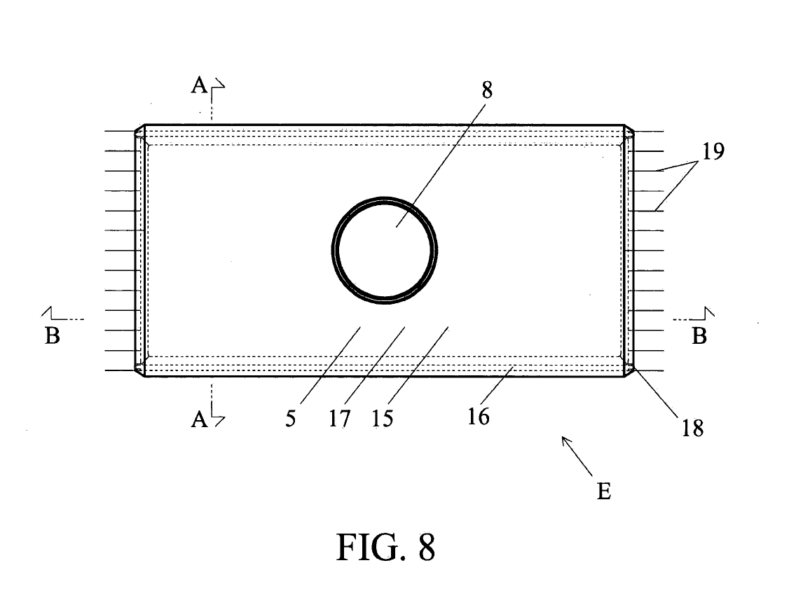

FIG. 9—showing longitudinal intersection of the elements made by intersection through A-A from picture 5

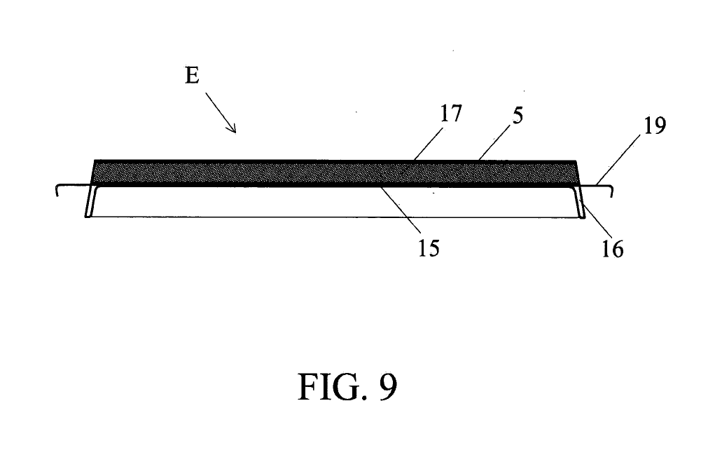

FIG. 10—showing cross section of the elements made by intersection through B-B from picture 5

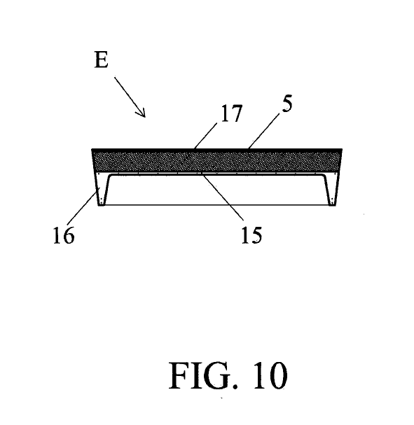

FIG. 11—showing outlook of the element, shown in the perspective bottom side view

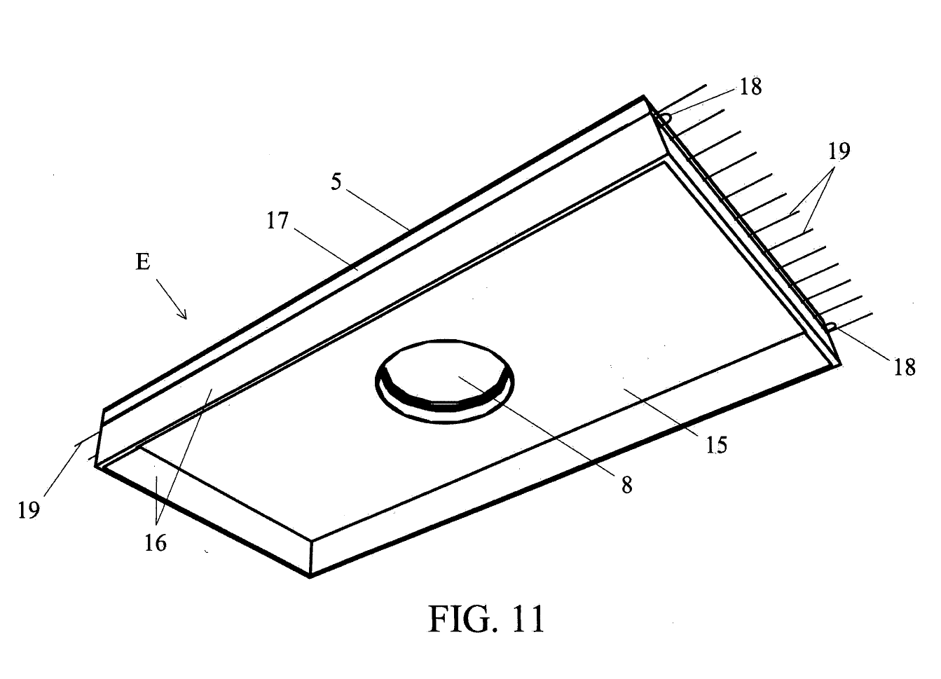

FIG. 12—showing outlook of the elements package from the bird perspective.

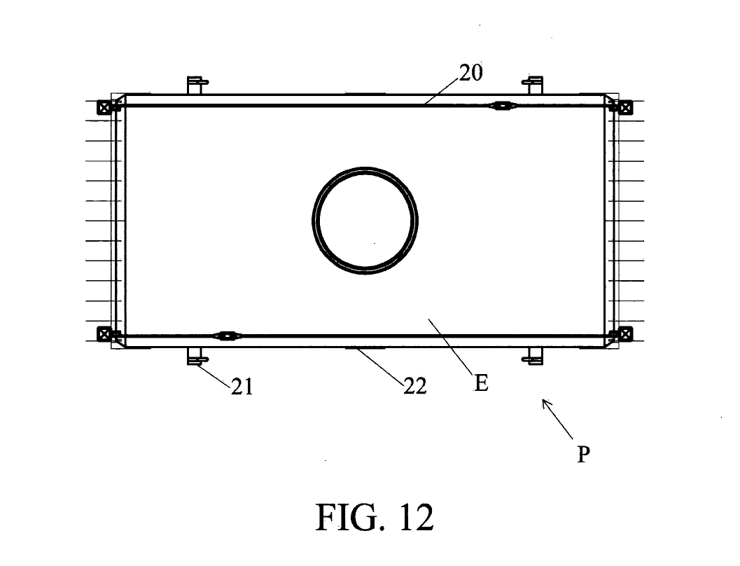

FIG. 13—showing package of the elements, side view

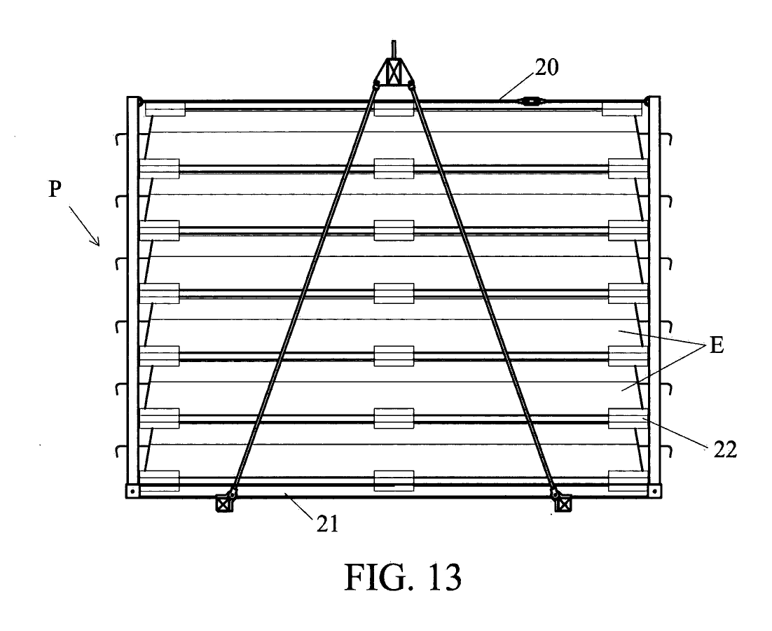

FIG. 14—showing package of the elements, frontal view

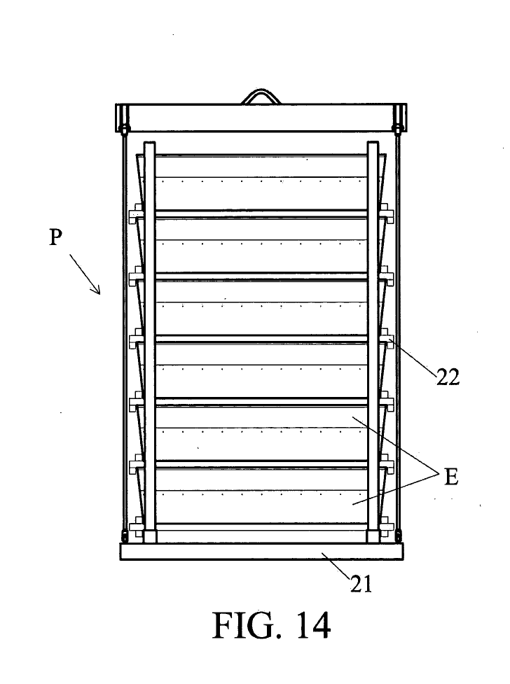

FIG. 15—showing package of the elements shown in perspective

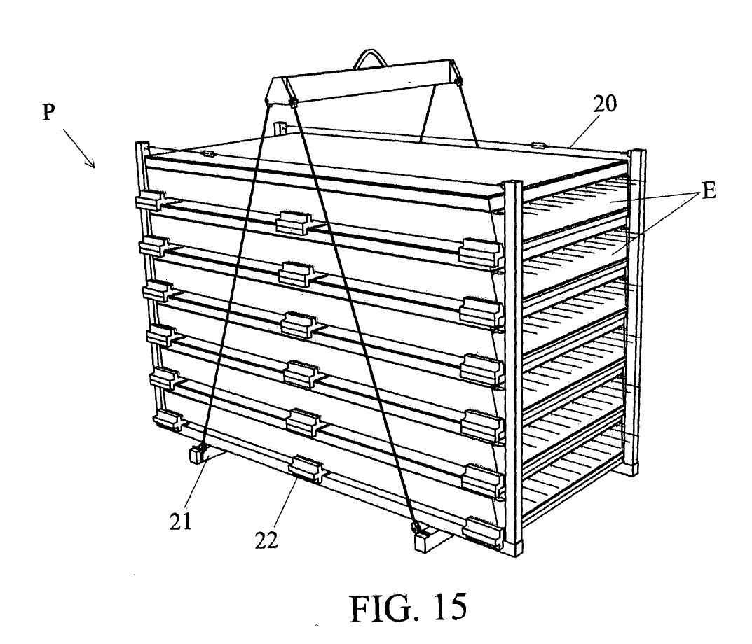

### BEST MODES FOR CARRYING OUT OF THE INVENTION

Core of the presented invention is in the new method of prefabrication of ferrocement elements E effused in special moulds K whose binding is done on the unique way and it's used for construction of the high rise structures. Prefabricated ferrocement elements E packed in special packets P and are transported on the construction site.

On the already prepared construction site according to the picture 1-3 first constructing of the two parallel reinforced—concrete foundation ribbon 1 is done on the space of planned diameter and throughout entire length of the structure. Next step is effusion of the reinforced—concrete panels 2 between foundational ribbons 1 which will serve as floor plate.

After strengthening concrete in the foundational ribbons 1 and floor 2 of the future structure, arched scaffold 3 is positioned using crane. Scaffold is made from four sided steel grid carrier which are connected with interconnections. Arched scaffold 3 has double role: 1) to define geometry of the future object and to serve as a scaffold for the workers during construction of the structure. On the brim of the grid steel bearing arched scaffold 3 adjustable endings 4 have been positioned in order to enable precise placement of ferrocement elements E on them.

Assembly of the elements starts in a way that with use of high quality construction glue two elements E are placed on the foundational ribbons—spreads 1 on both sides of arched scaffold 3 together with space left for effusion of reinforced-armored arch 6. Space is armored from external and internal side and closed with metal plates (casings) 7 together bonded with wire after which holes (cavities) are filled with effused concrete. Assembly is continued with placement of next row of elements E from both sides of scaffold one after another together with gluing (building) on already positioned elements Process is repeated until the top of arched scaffold is reached. In that way reinforced armored arch 6 is formed in which lengthy armor 19—“moustache” of ferrocement elements is constrained.

Arch 6 formed in such a way have a role of main carrying structure. Width of the arched scaffold 3 is determining number of arches 6 which will be effused at the same time. After strengthening reinforced concrete arch 6 metal plating 7 is removed and adjustable endings 4 on the radius of the arched scaffold 3 are retracted and they are enabling individual gridded carriers to be demounted and used again for support of next segment of the structure.

Construction is continued moving and lifting of the next two gridded carriers of arched scaffold 3 and “constructions” of next two arched rows of ferrocement elements E and by successive effusion of reinforced armored arch 6 until projected length of the structure is reached.

Process of construction is finished (roof and façade walls) by assembly of the elements and their monolithisation. It is important to mention that façade walls and ceiling made in such a way do not require plastering because the elements with their surface provide finishing layer of the indoor space (high quality mortar). The only thing required is painting of interior. This way significant savings of time and material are achieved because it is possible to build 1000 m² of enclosed space in only 20 days.

Indoor space of the structure then needs to be equipped according to the need of the end user and future purpose of the structure by placing dividing walls or split level ceiling which would divide structure vertically. In this segment high flexibility of structure is the most obvious because it enables any configuration of the rooms to be done in the indoor space and many different purposes of the structure to be achieved. This system enables significant portion of work to be moved inside of the structure which again enables construction to be done during entire year (indoor).

Ferrocement elements E shown on the picture 8-11 are made by effusing in mould K shown on the picture 4-7.

Body 9 of the mould K is made from steel as steel grid construction covered with metal plating 10. Sides 11 of the mould are made from steel plates and are design in such a way to enable them to be translational moved away from the mould so that element can be removed. Body 9 of the mould and his sides are placed on the carrier 12 of the mould and connection is embroidered with rubber bearers 13 Under the body of the mould K electro vibrating—motor 14 is positioned and he is contributing to the structural monoliths of ferrocement elements E.

Prefabricated ferrocement elements E have a role to fulfill meaning their role is not to be carrying elements. Carrying elements of high rise structures made in such a way are reinforced-armored arches 6 which can be formed by effusion on the construction site itself in space between arched rows of ferrocement elements E.

Ferrocement element E has sandwich structure and he consist from: box looking shell 15 made from ferrocement 2-3 cm thickness with fortified ribs 16 thermal isolation layer 17 and protective layer 5. For removing elements E from the mould K and his placement on the construction site armature hooks 18 protruding from the ribbed part of elements are used. “Moustaches” 19 protruding from frontal side of elements E, made from armature are used for binding elements E with armature in reinforced concrete arches 6. Optionally elements E can be made with the openings 8 for windows, ventilation or other installations.

Ferrocement element E has been attested on the Faculty of Civil Engineering in Nish, Republic of Serbia.

Ferrocement is thin composite which consist of layers of wire with space between them drenched in to the cement mortar. Compared to reinforced-concrete ferrocement represent steel (wire net) equally distributed all over the intersection of ferrocement element. Therefore ferrocement elements are significantly thinner; they weigh less than concrete but have same characteristics. Standard thickness of ferrocement elements is 10-30 mm. Using ferrocement technology, already one and half of the century, different sailing objects have been build in which ferrocement structure was exposed to big dynamic pressure.

Thermal isolating layer consists of “Simprolit”—polystyrene balls in cement milk. Simprolit is officially tested and it's scientifically proven that it can resist to the fire up to 3 hours. Simprolit is porous doesn't absorb humidity which enables him to withstand high number of soaking and freezing cycles meaning that he is suitable for all weather seasons.

Pictures 12-15 are showing process of packing for the ferrocement elements E on the metal palettes 21 provided for transportation to the construction site.

After removing elements E from mould K they are placed in packets P (6 pieces by height) on the special metal palettes 21. Between elements E wooden inserts are placed 22 and they are all tied down together with brackets 20 for the safety of the transport.

On the standard transportation truck it is possible to load three packets P of elements. Such a transport is in the frame of overall transportation parameters. This process enables that approximately 90 m² of the floor for structure—17 m² in length is transported in one direction. For loading of elements in to the truck only standard auto crane or forklift is needed.

This transportation solution enables half cylindrical structure with exterior range of 17 m, 800 m² of surface, equivalent to 5000 m³ cubage of indoor space; all prefabricated elements can be transported to the construction site in only 10 rounds.

By using arched shape of structure significant savings have been achieved (due to exceptional static system), compared to classical girder or frame construction (in general all the objects rectangular shape). Besides static and seismic influence of wind and dynamic pressure (which is increasingly prominent due to the climate change) is drastically reduced. Wind is just sliding across construction and there are no tiles or metal roof elements that can be detached from structure.

More favorable ratio of cubage and size of the floor enable savings in heating. Smaller size of the floor additionally reduces loss of heat but also undesired heating from the sun during the summer consequentially costs of cooling and heating are also reduced.

Because windows are located on the steep surface they are significantly contributing to the reducing of the heat loss. They are smaller in dimensions but they provide same light as windows on the vertical walls.

Structures are attractive, durable, easy to maintain and price is 20% lower than price of standard construction.

Structure made from prefabricated elements can be used for production, business, sport as residential space or it can have any other purpose. This flexibility is achieved with independent construction of external half cylindrical shell and internal dividing walls and ceilings.

1. Prefabricated construction structure constructed using ribbed prefabricated ferrocement elements sandwich type effused in moulds with already effused reinforced-concrete ribbons 1 and floor plate 2 it is indicated in a way that on demountable steel arched scaffold 3 which has adjustable endings on its edges 4, with gluing using construction glue two arched rows of prefabricated elements have been placed E; space is left between them for placement of steel armor, embraced with both (external, internal) side with metal plates—plating 7 connected with wire in which concrete has been successively effused for forming of main carrying reinforced—armored arch 6 in which armature—“moustache” 19 of ferrocement elements E are constraint after which plating 7 is removed as well as arched scaffold 3.

2. Mould for effusion of ferrocement elements E is made from steel grid construction it is indicated in a such a way that body 9 of the mould K is cover with metal plating 10 and with translational movable edges so that elements can be removed; body 9 of the mould and its sides 11 are placed on the carrier 12 of the mould embroidered with rubber bearing 13 while under the body 9 of the mould, vibrating motor has been placed 14.

3. Prefabricated ribbed ferrocement element E is indicated in a way that he is effused in the mould K and it consist from box looking shell 15 made from ferrocement 2-3 cm thickness with fortifying ribs 16 thermal isolation layer 17 and protective layer 5: on the side of the elements E hooks 18 have been positioned and “moustaches” 19 made from armature and used for removing elements from the mould K and his placement on the construction site and on the armature of the reinforced concrete arches 6; they have an optional openings 8 made for windows, ventilation and other installation; like elements E after they have been removed from mould K sorted on the metal pallets 21 and in packages P and secured using brackets 20.
